(19) United States
(12) Patent Application Publication
(10) Pub. No.: US 2015/0081431 A1
(43) Pub. Date: Mar. 19, 2015

(54) POSTERIOR PROBABILITY CALCULATING APPARATUS, POSTERIOR PROBABILITY CALCULATING METHOD, AND NON-TRANSITORY COMPUTER-READABLE RECORDING MEDIUM

(71) Applicant: YAHOO JAPAN CORPORATION, Tokyo (JP)

(72) Inventors: Daii AKAHOSHI, Tokyo (JP); Carlos KOBASHIKAWA, Tokyo (JP); Yuta KIKUCHI, Tokyo (JP)

(21) Appl. No.: 14/329,048

(22) Filed: Jul. 11, 2014

(30) Foreign Application Priority Data
Sep. 18, 2013 (JP) 2013-192521

(51) Int. Cl. G06Q 30/02

(52) U.S. Cl. CPC G06Q 30/0254
USPC 705/14.52

(57) ABSTRACT

A posterior probability calculating apparatus that calculates the posterior probability in a short time includes a user information storage unit, a prior probability calculating unit, a likelihood calculating unit, an accepting unit, a posterior probability calculating unit, and an output unit. The user information storage unit stores user information that associates a user attribute and log information. The prior probability calculating unit calculates the prior probability that a user has a certain user attribute. The likelihood calculating unit calculates the likelihood that a user with a certain user attribute has performed a certain event. The accepting unit accepts calculation target information. The posterior probability calculating unit calculates the posterior probability that a user who has performed an event included in log information included in the accepted calculation target information has a user attribute included in the calculation target information. The output unit outputs information regarding the posterior probability.

### CROSS-REFERENCE TO RELATED APPLICATIONS

The present invention contains subject matter related to Japanese Patent Application No. 2013-192521 filed in the Japan Patent Office on Sep. 18, 2013, the entire contents of which are incorporated herein by reference.

### BACKGROUND OF THE INVENTION

1. Field of the Invention

The present invention relates to a posterior probability calculating apparatus and the like which calculate the probability that a user has a certain user attribute.

2. Description of the Related Art

In web ads, a technique referred to as “audience enhancement” has been used. Audience enhancement is a technique that estimates a user attribute by using web browsing and search histories, and distributes an ad to a user estimated to have a target user attribute.

Note that, as related technology, there has been developed a method of analyzing character strings included in a web page that a user is browsing, for example, selecting an ad that matches that web page, and providing the ad, which suits the user (for example, see Japanese Unexamined Patent Application Publication No. 2009-145968).

In such audience enhancement, there has been a demand for performing audience enhancement in real time for a user who has visited a certain web site or a user who has entered a certain search keyword.

In general, when a certain user performs some sort of event regarding a web page, there has been a demand for calculating the probability that the user has a certain user attribute in a short period of time.

### SUMMARY OF THE INVENTION

The present invention provides a posterior probability calculating apparatus and the like which are capable of calculating the probability that a user who has performed an event regarding a web page has a certain user attribute in a short period of time.

According to an aspect of the present invention, there is provided a posterior probability calculating apparatus including a user information storage unit, a prior probability calculating unit, a likelihood calculating unit, an accepting unit, a posterior probability calculating unit, and an output unit. The user information storage unit stores a plurality of items of user information. The user information is information that associates a user identifier for identifying a user, a user attribute of the user, and log information that is a log of an event performed by the user regarding a web page. The prior probability calculating unit calculates, for each user attribute, a prior probability that is a probability that a user has a certain user attribute, by using the plurality of items of user information. The likelihood calculating unit calculates, for each combination of a user attribute and an event, a likelihood that is a probability that a user with a certain user attribute has performed a certain event, by using the plurality of items of user information. The accepting unit accepts calculation target information including event log information and a user attribute. The posterior probability calculating unit calculates, according to the naive Bayes method using the prior probabilities and the likelihoods, a posterior probability that is a probability that a user who has performed each event included in the log information included in the calculation target information accepted by the accepting unit has the user attribute included in the calculation target information. The output unit outputs information regarding the posterior probability calculated by the posterior probability calculating unit.

The posterior probability calculating unit may calculate a to-be-normalized posterior probability that is a value in accordance with a posterior probability corresponding to the calculation target information. The posterior probability calculating unit may additionally calculate a to-be-normalized posterior probability for each user attribute included in a set obtained by excluding the user attribute included in the calculation target information accepted by the accepting unit from a set of user attributes corresponding to all users, and may calculate the posterior probability corresponding to the calculation target information by normalizing the to-be-normalized posterior probability corresponding to the calculation target information using the to-be-normalized posterior probability.

The log of an event may be the log of an event for each type of device with which the event has been performed. The prior probability calculating unit may calculate the prior probability for each type of device. The accepting unit may accept calculation target information that additionally includes device type information indicating a type of device. The posterior probability calculating unit may calculate a posterior probability corresponding to the type of device indicated by the device type information included in the calculation target information accepted by the accepting unit by using a prior probability and a likelihood in accordance with the type of device.

The event may be at least one of browsing a web page and entering a search keyword.

The posterior probability calculating apparatus may further include a determination unit that determines whether a user who has performed each event in the log of an event included in the calculation target information accepted by the accepting unit has the user attribute included in the calculation target information by determining whether a posterior probability calculated in accordance with the calculation target information is greater than or equal to a predetermined threshold. The output unit may output a determination result obtained by the determination unit.

According to the posterior probability calculating apparatus and the like, the probability that a user who has performed an event regarding a web page has a certain user attribute can be calculated in a short period of time.

### BRIEF DESCRIPTION OF THE DRAWINGS

FIG. 1 is a block diagram illustrating the configuration of a posterior probability calculating apparatus according to an embodiment;

FIG. 2 is a flowchart illustrating the operation of the posterior probability calculating apparatus according to the embodiment;

FIG. 3 is a diagram illustrating exemplary user information stored in a user information storage unit according to the embodiment;

FIG. 4 is a diagram illustrating exemplary prior probabilities and the like stored in a calculation information storage unit according to the embodiment;

FIG. 5 is a diagram illustrating an exemplary display performed by an output unit according to the embodiment;

FIG. 6 is a diagram illustrating an exemplary appearance of a computer system according to the embodiment; and

FIG. 7 is a diagram illustrating an exemplary configuration of the computer system according to the embodiment.

### DETAILED DESCRIPTION OF THE PREFERRED EMBODIMENTS

Hereinafter, a posterior probability calculating apparatus and the like according to an embodiment will be described with reference to the drawings. Elements with the same reference numerals in the embodiment perform the same or similar operation, and overlapping descriptions thereof may be appropriately omitted.

In the embodiment, a posterior probability calculating apparatus 1 that calculates the probability that a user corresponding to accepted event log information has an accepted user attribute by using already available user attribute information will be described.

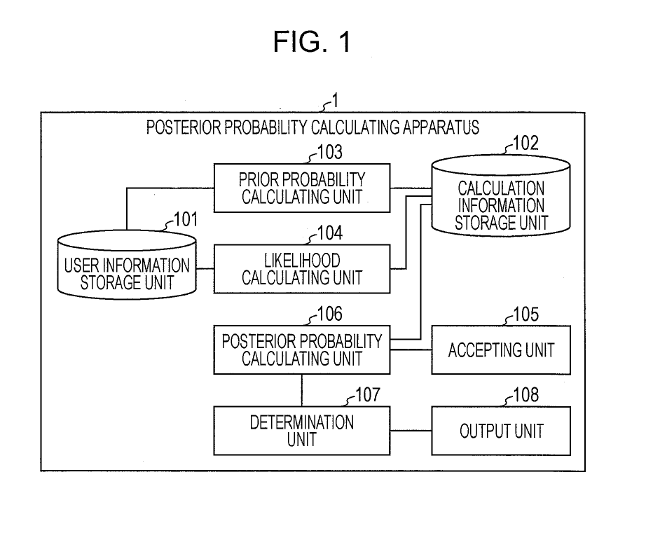

FIG. 1 is a block diagram of the posterior probability calculating apparatus 1 according to the embodiment. The posterior probability calculating apparatus 1 includes a user information storage unit 101, a calculation information storage unit 102, a prior probability calculating unit 103, a likelihood calculating unit 104, an accepting unit 105, a posterior probability calculating unit 106, a determination unit 107, and an output unit 108.

The user information storage unit 101 stores a plurality of items of user information. User information is information that associates a user identifier for identifying a user, the user attribute of that user, and that user's log information. A user identifier may be any information as long as it can identify a user. For example, a user identifier may be a user's name, address, telephone number, any combination thereof, identifier (ID) given to a user, or the like. In addition, a user identifier may be, for example, information of an ID for identifying user information stored in the user information storage unit 101. In the user information storage unit 101, in the case where there is a plurality of items of the same user information, a user identifier may be information used to uniquely merge these items of information.

A user attribute is information indicating the attribute of a user. Although a user attribute is generally information obtained from what a user has declared, a user attribute may be information obtained from what a user has done. For example, a user attribute may be information indicating a user's sex, information indicating a user's age, information indicating a user's generation, information indicating an area where a user lives, information indicating a user's family structure, information indicating a user's occupation, information indicating a user's educational background, information indicating a user's income, information indicating a user's shopping tendencies, information indicating a user's behavior tendencies, or any combination thereof.

Log information is information indicating the log of an event(s) performed by a user regarding a web page. That is, log information is information including one event or two or more events. An event may be at least one of the following: browsing a web page, entering a search keyword, and selecting an ad; or may be any other event performed regarding a web page. Therefore, information of an event included in log information may be, for example, information indicating that a user has browsed a specific web page, each search keyword entered by a user, or information indicating each ad selected by a user. Information indicating that a user has browsed a specific web page may be the identifier of that web page. Note that the identifier of a web page may be, for example, a uniform resource locator (URL), an ID for identifying the web page, which is stored in a storage unit that is not illustrated in the drawings, or the web page itself. In addition, a search keyword entered by a user may be one keyword or a combination of two or more keywords. In addition, information for identifying an ad selected by a user may be the ad itself, or an ID for identifying the ad, which is stored in a storage unit that is not illustrated in the drawings. In the embodiment, the case in which events are browsing a web page and entering a search keyword will be mainly described. In short, the case in which log information is information including at least one of the identifier of a web page and a search keyword will be mainly described in the embodiment. In addition, log information may further include information other than those described above. For example, for each event, log information may include the date and time at which that event has occurred.

Log information may be the log of an event(s) for each type of device with which the event(s) included in the log information has/have been performed. That is, events executed by one and the same user using different devices may be treated as different items of log information, or may be treated as the same log information. In the case where log information is information according to each type of device, device type information indicating the type of device and log information may be stored in association with each other in the user information storage unit 101, or log information including device type information may be stored in the user information storage unit 101. Note that the types of device include, for example, a personal computer (PC), tablet, smartphone, and so forth.

Note that “associating a user identifier, a user attribute, and log information” means that it is sufficient if any one of these items of information is specifiable from another one of these corresponding items of information. Therefore, association information may be information including a user identifier, a user attribute, and log information, or may be information for linking these items of information. In addition, association information may be divided into two or more items of information. For example, association information may be a set of information that associates a user identifier and a user attribute and information that associates the user identifier and log information.

The calculation information storage unit 102 stores prior probabilities and likelihoods used for calculating a posterior probability with the posterior probability calculating unit 106. Note that a prior priority may be stored in association with information for identifying what the prior probability is of. In addition, a likelihood may be stored in association with information for identifying what the likelihood is of. Note that prior probabilities are accumulated by the prior probability calculating unit 103. In addition, likelihoods are accumulated by the likelihood calculating unit 104. Prior probabilities and likelihoods will be described later.

The prior probability calculating unit 103 calculates the prior probability for each user attribute by using a plurality of items of user information. The prior probability is the probability that a user has a certain user attribute. The prior probability is the proportion of users having a specific user attribute in all items of user information stored in the user information storage unit 101. The prior probability may be the proportion of any set that can be obtained from user information among all items of information stored in the user information storage unit 101. For example, in the case where a user attribute indicating the sex is included, the prior probability may be the proportion that the sex indicated by the user attribute is male, that is, the probability that the user is male, or the proportion that the sex indicated by the user attribute is female, that is, the probability that the user is female. The prior probability that the user is male can be calculated as follows, for example. Note that the number of male users may be the number (unique number) of user identifies corresponding to the user attribute “male”, and the total number of users may be the number (unique number) of user identifiers.

prior probability=number of male users/number of all users

In addition, for example, in the case where a user attribute indicating age or generation is included, the prior probability may be, for example, the proportion that the age or generation indicated by the user attribute is twenties, that is, the probability that the user is in his/her twenties.

Note that it is suitable in the prior probability calculating unit 103 to calculate the prior probability using a user identifier, without counting the same user twice or more. In addition, in the case where log information is different for types of device, the prior probability calculating unit 103 may calculate the prior probability for each type of device. For example, the prior probability calculating unit 103 may calculate the probability that a user using a tablet is male. In addition, the prior probability calculating unit 103 may calculate the prior probability by converting a user attribute. For example, in the case of a user attribute indicating 23 years old, this user attribute may be converted to twenties or converted to from 20 to 29 years old. In addition, the prior probability calculating unit 103 may accumulate the calculated prior probability in association with an identifier for identifying what the prior probability is of (such as “male”, “female”, “twenties”, “thirties”, etc.) in the calculation information storage unit 102.

The likelihood calculating unit 104 calculates the likelihood which is the probability that a user with a certain user attribute has performed a certain event, by using a plurality of items of user information. The likelihood calculated by the likelihood calculating unit 104 is the proportion according to each combination of a user attribute and an event. The likelihood is the proportion that a specific event is included in user information with a specific user attribute stored in the user information storage unit 101. For example, the likelihood may be the proportion that the log of browsing a specific web page is included, the proportion that the log of a specific search keyword is included, or the proportion that the log of selecting a specific ad is included in user information with the user attribute “male”. Specifically, the likelihood which is the probability that a user with the user attribute “male” has browsed web page A is as follows:

likelihood=number of times web page A is browsed by male users/total number of times web pages are browsed by male users

Similarly, the likelihood which is the probability that a user with the user attribute “male” has conducted a search with search keyword B is as follows:

likelihood=number of times search is conducted with search keyword B by male users/total number of times search is conducted by male users

Thus, the numerator for calculating the likelihood is the number of times users with a specific user attribute have performed a specific event, and the denominator thereof is the total number of times users with the specific user attribute have performed events regarding the type of event including the event in the numerator. The type of event may be, for example, browsing a web page, entering a search keyword, selecting an ad, or the like. Therefore, as has been described above, if the numerator is “browsing web page A” by users with a specific user attribute, the denominator is the “total number of times web pages are browsed” by users with the specific user attribute.

Note that the above-described exemplary likelihood may be each proportion regarding any attribute included in user attributes, such as the case of a user attribute indicating female, the case in which the age indicated by a user attribute is twenties, and the case in which the family structure indicated by a user attribute is a family of four. Note that the likelihood may be a smoothed value such that the proportion value does not become zero. Smoothing may be additive smoothing or smoothing using a heuristics technique. For example, the additive-smoothed likelihood has a numerator that is the sum of the number of times users with a certain user attribute have performed a specific event (for example, the number of times web page A has been browsed by male users) and N, and a denominator that is the sum of the total number of times users with the certain user attribute have performed events regarding the type of event to which that event belongs (for example, the total number of times web pages are browsed by male users) and N×(the number of different events in that type of event). Note that the number of different events in that type of event indicates the unique number of events in that type of event. That is, how the number of different events is counted is that, in the case where log information includes three web page identifiers, the number of different events is three. For example, in the case where the type of event is browsing a web page, the number of different events regarding browsing that web page is the unique number of web page identifiers included in the log information; in the case where the type of event is entering a search keyword, the number of different events regarding entering that search keyword is the unique number of search keywords included in the log information. In addition, it is assumed that N is a natural number greater than or equal to one. Various smoothing techniques including additive smoothing are the related art, and thus detailed descriptions thereof are omitted.

Note that it is suitable in the likelihood calculating unit 104 to calculate the likelihood using a user identifier, without counting the same user twice or more. In this case, it is suitable in the likelihood calculating unit 104 to calculate the likelihood by merging items of log information corresponding to the same user identifier. For example, in the case where there are different items of log information corresponding to the same user identifier, these items of log information may be merged. For example, in the case where one of items of log information corresponding to the same user identifier has the web page identifier “page A” and the other one of the items of log information has the web page identifier “page B”, these items of log information may be treated as log information indicating that a user with a user attribute corresponding to the user identifier has browsed two web pages with the web page identifiers “page A” and “page B”. In addition, in the case where log information is different for types of device, the likelihood calculating unit 104 may calculate the likelihood for each type of device. For example, the likelihood calculating unit 104 may calculate the likelihood that a male user using a tablet has browsed web page A. In addition, the likelihood calculating unit 104 may calculate the likelihood by converting a user attribute. For example, in the case of a user attribute indicating 23 years old, this user attribute may be converted to twenties or converted to from 20 to 29 years old. In addition, the likelihood calculating unit 104 may accumulate the calculated likelihood in association with an identifier for identifying what the likelihood is of (such as “user attribute: male, event: page A”, “user attribute: twenties, event: search keyword X”, etc.) in the calculation information storage unit 102.

The accepting unit 105 accepts calculation target information that has event log information and a user attribute. In addition, the accepting unit 105 may accept calculation target information that additionally has device type information indicating the type of device. The accepting unit 105 may accept a user attribute via an input device such as a mouse or a keyboard. In addition, the accepting unit 105 may accept calculation target information stored in a storage unit that is not illustrated in the drawings. In addition, the accepting unit 105 may receive calculation target information via a wired or wireless communication line. A communication line includes, for example, the Internet, an intranet, a local area network (LAN), and a public telephone circuit. In addition, the accepting unit 105 may accept, out of calculation target information, log information via an input device or a communication device and may read a user attribute from a storage unit that is not illustrated in the drawings. The storage unit may store user attributes corresponding to all users. The accepting unit 105 may sequentially read these user attributes corresponding to all users, thereby accepting calculation target information. For example, the storage unit may store the user attributes “male” and “female”, and the user attributes “less than 10 years old”, “from 10 to 19 years old”, “twenties”, . . . , “eighties”, “nineties”, and “100 years old and older”. Upon receipt of event log information, the accepting unit 105 may accept calculation target information including that log information and the user attribute “male” and calculation target information including that log information and the user attribute “female”. In doing so, it becomes possible to calculate the posterior probability of each user attribute corresponding to the accepted event log information.

The posterior probability calculating unit 106 calculates the posterior probability. The posterior probability is the probability that a user who has performed each event included in log information included in calculation target information accepted by the accepting unit 105 has a user attribute included in the calculation target information. Note that the posterior probability calculating unit 106 calculates the posterior probability according to the naive Bayes method using prior probabilities and likelihoods. Specifically, the posterior probability calculating unit 106 may calculate the posterior probability that a user who has performed events 1 to M included in log information N1 to NM times has user attribute A as follows:

$$posterior probability ∝ {P ( event 1 \text{/} user attribute A )}^{N 1} \times {P ( event 2 \text{/} user attribute A )}^{N 2} \times … \times {P ( event M \text{-} 1 \text{/} user attribute A )}^{N ( M - 1 )} \times {P ( event M \text{/} user attribute A )}^{NM} \times P ( user attribute A )$$

wherein P(user attribute A) is the prior probability that a user has user attribute A, and P(event 1/user attribute A) or the like is the likelihood that a user who has user attribute A has performed event 1 or the like. Therefore, the posterior probability calculating unit 106 is able to calculate the value of the above-mentioned right side using the prior probabilities calculated by the prior probability calculating unit 103 and the likelihoods calculated by the likelihood calculating unit 104. Since the value of the above-mentioned right side is a value proportional to the posterior probability, normalization may be performed, as described later. In addition, since the value of the right side is a value in accordance with the posterior probability, the value will be referred to as a “to-be-normalized posterior probability”. Here, a value in accordance with the posterior probability may be considered as a value obtained by multiplying the posterior probability by a certain value. This “certain value” may be the reciprocal of a denominator in the naive Bayes method. Since the naive Bayes method is the related art, a detailed description thereof is omitted.

In addition, since a calculation error in calculating the posterior probability as a product of probabilities is great, the posterior probability calculating unit 106 may calculate the logarithm of the posterior probability. That is, the posterior probability calculating unit 106 may calculate the logarithm of the posterior probability as follows:

$$log ( posterior probability ) ∝ N 1 \times log ( P ( event 1 \text{/} user attribute A ) ) + N 2 \times log ( P ( event 2 \text{/} user attribute A ) ) + … + N ( M \text{-} 1 ) \times log ( P ( event M \text{-} 1 \text{/} user attribute A ) ) + NM \times log ( P ( event M \text{/} user attribute A ) ) + log ( P ( user attribute A ) )$$

The above-calculated value of the above-mentioned right side may serve as the to-be-normalized posterior probability, and a value obtained by having the above-calculated value as the antilogarithm of the logarithm may serve as the to-be-normalized posterior probability.

Note that, as has been described earlier, the posterior probability calculating unit 106 may calculate the posterior probability corresponding to calculation target information by normalizing the to-be-normalized posterior probability corresponding to the calculation target information using the to-be-normalized posterior probability. In this case, the posterior probability calculating unit 106 may calculate the to-be-normalized posterior probability for each user attribute included in a set obtained by excluding a user attribute included in calculation target information accepted by the accepting unit 105 from the set of user attributes corresponding to all users. Note that it is possible to cover all users by a user attribute included in calculation target information and each user attribute included in a set obtained by excluding that user attribute from the set of user attributes corresponding to all users. In addition, it is preferable that a user attribute included in the set of user attributes corresponding to all users do not overlap other user attributes in that set. In addition, the set of user attributes corresponding to all users may be, for example, “male, female”, “less than 20 years old, from 20 to 39 years old, 40 years old and older”, and so forth. For example, in the case where the user attribute “male” is included in calculation target information, a set obtained by excluding the user attribute “male” from the set of user attributes {male, female} corresponding to all users becomes the user attribute “female”. In addition, for example, in the case where the user attribute “from 10 to 19 years old” is included in calculation target information, a set obtained by excluding the user attribute “from 10 to 19 years old” from the set of user attributes {less than 10 years old, from 10 to 19 years old, twenties, thirties, etc.} corresponding to all users becomes {less than 10 years old, twenties, thirties, etc.}. In addition, the posterior probability calculating unit 106 may normalize the to-be-normalized posterior probability corresponding to calculation target information by dividing the to-be-normalized posterior probability corresponding to the calculation target information by the sum of to-be-normalized posterior probabilities corresponding to all users. This normalized value becomes the posterior probability corresponding to the calculation target information. In the case where the to-be-normalized posterior probability is calculated using a logarithm, normalization may be performed using the to-be-normalized posterior probability that has the to-be-normalized posterior probability as the antilogarithm of the logarithm. In addition, the posterior probability calculating unit 106 may perform normalization by calculating the to-be-normalized posterior probability corresponding to a user attribute that is a complement of a user attribute included in calculation target information, and by using the calculated to-be-normalized posterior probability.

In addition, the posterior probability calculating unit 106 may convert a user attribute included in accepted calculation target information. For example, in the case of a user attribute indicating 23 years old, the posterior probability calculating unit 106 may convert this user attribute to twenties, from 20 to 29 years old, or the like. Note that, in the case where log information is different for types of device, the posterior probability calculating unit 106 may calculate the posterior probability corresponding to the type of device indicated by device type information included in calculation target information accepted by the accepting unit 105 by using the prior probabilities and the likelihoods in accordance with the type of device. For example, the posterior probability calculating unit 106 may calculate the posterior probability that a user who has performed each event of log information included in calculation target information using a tablet has a user attribute included in the calculation target information.

The determination unit 107 may determine whether a user who has performed each event of event log information included in calculation target information accepted by the accepting unit 105 has a user attribute included in the calculation target information by determining whether the posterior probability calculated in accordance with the calculation target information is greater than a predetermined threshold. The predetermined threshold may be, for example, a numeral determined empirically or a numeral obtained by calculation. The predetermined threshold may be set by a developer, an administrator, or the like, for example. The threshold is stored in a recording medium that is not illustrated in the drawings, and the determination unit 107 may read and use the threshold. In addition, the determination unit 107 may determine that the user has the user attribute in the case where the posterior probability exceeds the predetermined threshold.

The output unit 108 outputs information regarding the posterior probability calculated by the posterior probability calculating unit 106. The output unit 108 may output, for example, the posterior probability itself, may output the result of determination performed on the posterior probability, that is, the determination result obtained by the determination unit 107, or may perform another output regarding the posterior probability. In the embodiment, the case in which the output unit 108 outputs the result of determination performed on the posterior probability will be mainly described.

Note that information output by the output unit 108 may be used in drawing an ad by an apparatus other than the posterior probability calculating apparatus 1, which is not illustrated in the drawings. The apparatus not illustrated in the drawings may be an apparatus that stores an ad associated with user information, and selects an ad corresponding to a user attribute whose posterior probability is greater than or equal to the predetermined threshold.

Although the user information storage unit 101 and the calculation information storage unit 102 are preferably non-volatile recording media, the user information storage unit 101 and the calculation information storage unit 102 can be realized with volatile recording media. Note that the process of storing user information in the user information storage unit 101 does not matter. For example, user information may be stored in the user information storage unit 101 via a recording medium, or user information transmitted via a communication line or the like may be stored in the user information storage unit 101. Alternatively, user information input via an input device may be stored in the user information storage unit 101.

The prior probability calculating unit 103, the likelihood calculating unit 104, the posterior probability calculating unit 106, the determination unit 107, and the output unit 108 are generally realized from a microprocessing unit (MPU), a memory, and so forth. A procedure of the prior probability calculating unit 103 is generally realized with software, and the software is recorded on a recording medium such as a read-only memory (ROM). Alternatively, the procedure may be realized with hardware (dedicated circuit).

The output unit 108 may perform the following: displaying on a display, projection using a projector, outputting to a loudspeaker or the like, printing with a printer, transmission to an external apparatus, accumulation in a recording medium, and transferring the processing result to another processing apparatus or another program.

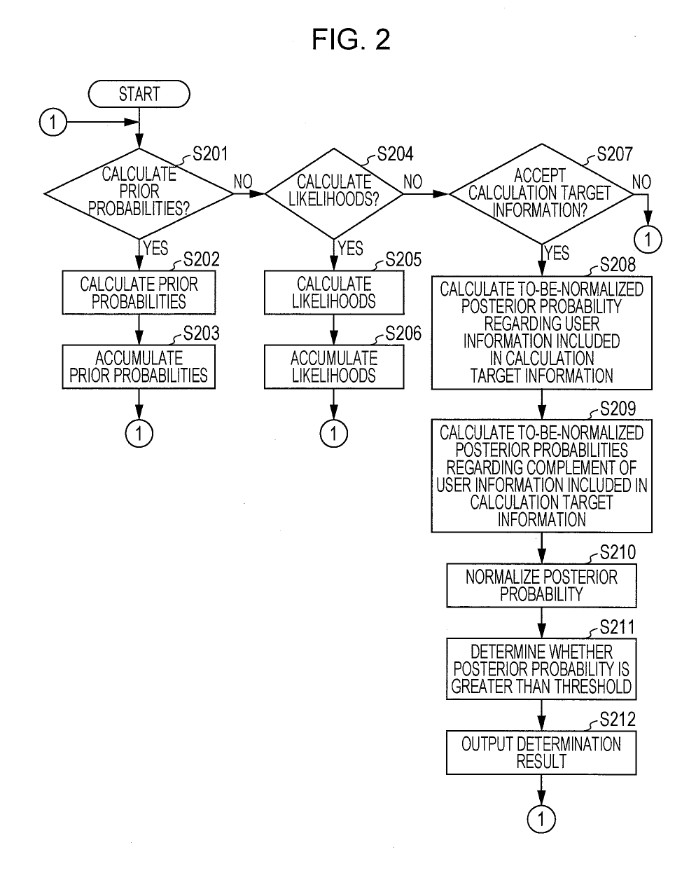

Next, the operation of the posterior probability calculating apparatus 1 will be described using the flowchart illustrated in FIG. 2.

(step S201) The prior probability calculating unit 103 determines whether to calculate prior probabilities. In the case of calculating prior probabilities, the process proceeds to step S202; otherwise, the process proceeds to step S204. Note that the prior probability calculating unit 103 may periodically (such as everyday or every week) determine to calculate prior probabilities, or may determine to calculate prior probabilities in the case where no prior probability is stored in the calculation information storage unit 102.

(step S202) The prior probability calculating unit 103 calculates the prior probabilities corresponding to all user attributes for each type of device by using user information stored in the user information storage unit 101.

(step S203) The prior probability calculating unit 103 accumulates all the prior probabilities calculated in step S202 in the calculation information storage unit 102. Then, the process returns to step S201. Note that the prior probability calculating unit 103 may repeat calculation and accumulation of the prior probability(ies) for each type of device or for each user attribute. In that case, processing in steps S202 and S203 is repeatedly executed for each type of device or for each user attribute.

(step S204) The likelihood calculating unit 104 determines whether to calculate likelihoods. In the case of calculating likelihoods, the process proceeds to step S205; otherwise, the process proceeds to step S207. Note that the likelihood calculating unit 104 may periodically (such as everyday or every week) determine to calculate likelihoods, or may determine to calculate likelihoods in the case where no likelihood is stored in the calculation information storage unit 102.

(step S205) The likelihood calculating unit 104 calculates the likelihoods corresponding to all combinations of a user attribute and an event for each type of device by using user information stored in the user information storage unit 101.

(step S206) The likelihood calculating unit 104 accumulates all the likelihoods calculated in step S205 in the calculation information storage unit 102. Then, the process returns to step S201. Note that the likelihood calculating unit 104 may repeat calculation and accumulation of the likelihood(s) for each type of device or for each user attribute. In that case, processing in steps S205 and S206 is repeatedly executed for each type of device or for each user attribute.

(step S207) The accepting unit 105 determines whether calculation target information has been accepted. In the case where calculation target information has been accepted, the process proceeds to step S208; otherwise, the process returns to step S201.

(step S208) The posterior probability calculating unit 106 calculates the to-be-normalized posterior probability regarding a user attribute included in the calculation target information accepted in step S207 by using the prior probabilities calculated in step S202 and the likelihoods calculated in step S205.

(step S209) The posterior probability calculating unit 106 calculates the to-be-normalized posterior probabilities regarding all user attributes included in a complement of the user attribute included in the calculation target information accepted in step S207 by using the prior probabilities calculated in step S202 and the likelihoods calculated in step S205.

(step S210) The posterior probability calculating unit 106 calculates the posterior probability regarding the user attribute included in the calculation target information by normalizing the to-be-normalized posterior probability regarding that user attribute using the posterior probabilities calculated in step S208 and S209.

(step S211) The determination unit 107 determines whether the posterior probability calculated in step S210 is greater than or equal to a predetermined threshold.

(step S212) The output unit 108 outputs the determination result obtained in step S210. Then, the process returns to step S201.

Note that, in step S207, in the case where log information has been accepted, the accepting unit 105 may accept calculation target information, that is, the log information and a user attribute, by reading the user attribute from a storage unit that is not illustrated in the drawings. In addition, in the case where log information has been accepted, the accepting unit 105 may sequentially read user attributes corresponding to all users from a storage unit that is not illustrated in the drawings, and repeat processing in steps S208 to S212 on the user attributes, thereby determining whether a user who has executed each event of the accepted log information has each of the user attributes corresponding to all users. In doing so, for example, users who correspond to certain log information may be determined as “male,” not “female”, or determined as “from 10 to 19 years old”, “twenties”, and “thirties”, but not “less than 10 years old”, “forties”, or “fifties”. In addition, in the flowchart illustrated in FIG. 2, the process ends when the power is turned off or in response to a process end interruption.

Hereinafter, the specific operation of the posterior probability calculating apparatus 1 according to the embodiment will be described. In this specific example, it is assumed that no data is stored in the calculation information storage unit 102. Also in this specific example, it is assumed that a user attribute is information that indicates whether a user indicated by that user attribute is male or female. Also in this specific example, it is assumed that log information is information for identifying a browsed web page.

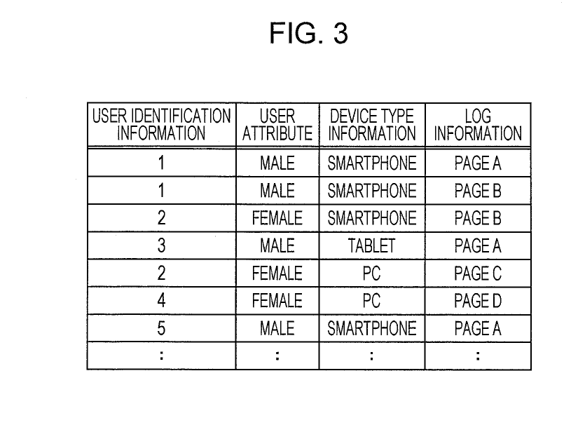

In this specific example, it is assumed that user information stored in the user information storage unit 101 is that illustrated in FIG. 3. A table illustrated in FIG. 3 has a user identifier, a user attribute, device type information, and log information. For example, the first user information (record) included in the table illustrated in FIG. 3 has “user identifier: 1”, “user attribute: male”, “device type information: smartphone”, and “log information: page A”. It is assumed that this user information indicates that a user identified by the user identifier “1” is male, and this user has browsed page A using a smartphone. User information included in the table illustrated in FIG. 3 may be information of a user who has, for example, a user ID of a search engine, a portal site, or the like. A user attribute in that case may be input by the user at the time the user has obtained the user ID, and log information may be information obtained at the time the user has conducted a search or browsed a page while being logged in with the user ID.

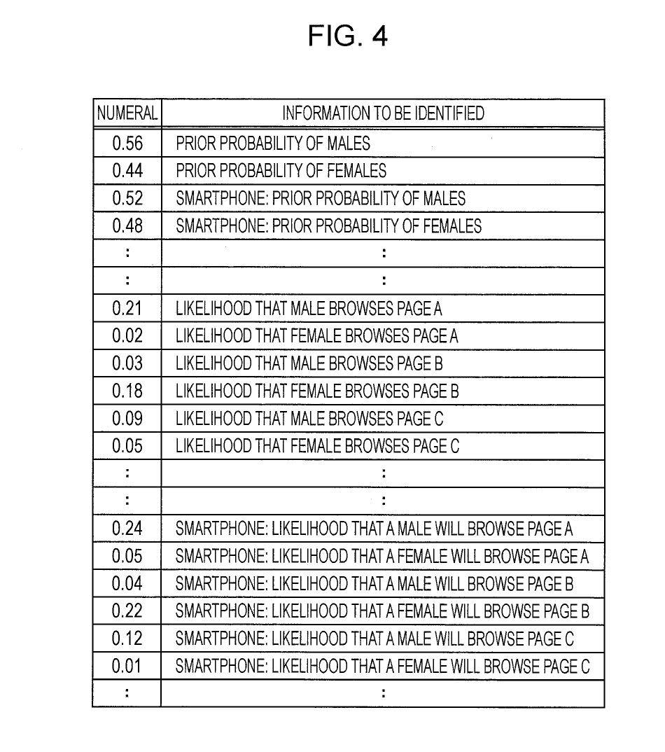

It is assumed that a user activates the posterior probability calculating apparatus 1 and starts a process. The prior probability calculating unit 103 calculates the prior probabilities corresponding to all user attributes, for each item of device type information, by using the user information stored in the user information storage unit 101 (from step S201 to step S202). The prior probability calculating unit 103 accumulates the calculated prior probabilities in the calculation information storage unit 102 (step S203). For example, the first to fourth records in FIG. 4 are information accumulated in such a manner.

The likelihood calculating unit 104 calculates the likelihoods corresponding to all combinations of a user attribute and an event, for each item of device type information, by using the user information stored in the user information storage unit 101 (from step S204 to step S205). The likelihood calculating unit 104 stores the calculated likelihoods in the calculation information storage unit 102 (step S206). For example, records including the identifying information “likelihood that male browses page A” and “smartphone: likelihood that male browses page A” in FIG. 4 are information accumulated in such a manner.

Thereafter, it is assumed that a certain user is browsing a web page, and an ad is to be drawn to that user. Then, the device type information “smartphone” of a device that the user is using and log information {page A: 4, page B: 1, page C: 3 . . . } are transferred to the posterior probability calculating apparatus 1. Note that the device type information can be obtained using a user agent. In addition, the log information can be obtained using a cookie or the like. Upon acceptance of the device type information and the log information, the accepting unit 105 of the posterior probability calculating apparatus 1 reads the user attribute “male” stored in a storage unit that is not illustrated in the drawings, thereby accepting calculation target information including the device type information “smartphone”, the log information {page A: 4, page B: 1, page C: 3 . . . }, and the user attribute “male” (step S207). Then, the posterior probability calculating unit 106 obtains the to-be-normalized posterior probability “1.34” regarding the user attribute “male” included in the calculation target information, and the to-be-normalized posterior probability “0.66” regarding the user attribute “female” which is a complement of the user attribute “male” (from step S208 to step S209). In addition, using these to-be-normalized posterior probabilities, the posterior probability calculating unit 106 normalizes the to-be-normalized posterior probability regarding the user attribute “male”, and calculates the posterior probability “0.67” corresponding to the user attribute “male” (=1.34/(1.34+0.66)) (step S210). The posterior probability calculating unit 106 executes similar processing on the user attribute “female”, and calculates the posterior probability “0.33” corresponding to the user attribute “female” (steps S208 to S212).

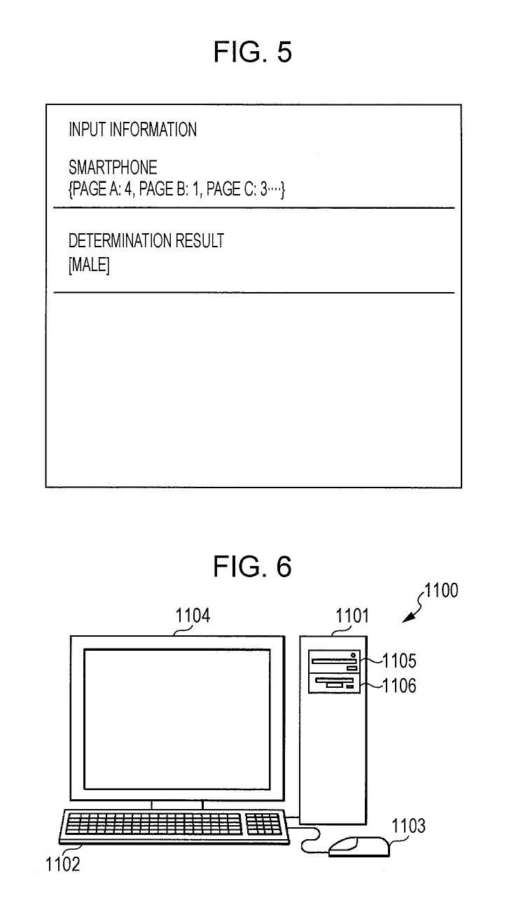

When calculation of the posterior probabilities by the posterior probability calculating unit 106 ends, the determination unit 107 determines whether these posterior probabilities are greater than the threshold “0.6” (step S211). Since the posterior probability “0.67” corresponding to the user attribute “male” is greater than the threshold “0.6”, the determination unit 107 determines that the log information included in the calculation target information is of male. In addition, since the posterior probability “0.33” corresponding to the user attribute “female” is less than the threshold “0.6”, the determination unit 107 determines that the log information included in the calculation target information is not of female. The output unit 108 transfers the determination result to an apparatus that draws an ad, and displays the determination result on a display of the posterior probability calculating apparatus 1 as illustrated in FIG. 5. The apparatus which draws an ad is to draw an ad for men to the user in accordance with the accepted determination result.

Although the case in which one item of log information includes the identifier of one web page has been described in this specific example as illustrated in FIG. 3, the specific example is not be limited to this case. Needless to say, one item of log information may include the identifiers of two or more web pages. In addition, the to-be-normalized posterior probability “0.66” regarding the user attribute “female”, which is a complement of the user attribute “male”, may be temporarily stored, and, by using this posterior probability, the posterior probability corresponding to the user attribute “female” may be calculated.

As has been described above, according to the posterior probability calculating apparatus 1 according to the embodiment, for example, even for a user whose user ID is not registered, the probability that the user has a certain user attribute can be calculated by using the user's log information. In addition, the posterior probability calculating unit 106 calculates the posterior probability using the already calculated prior probabilities and likelihoods, thereby calculating the posterior probability in a short period of time. In addition, the posterior probability calculating unit 106 calculates the posterior probability by performing normalization, thereby calculating the posterior probability without calculating a denominator in the naive Bayes method. In addition, since the user information storage unit 101 stores user information for each device, the posterior probability calculating unit 106 can also calculate the posterior probability for each device. For example, highly accurate estimation becomes possible even for a user who has different browsing tendencies with different devices. In addition, whether a user has a certain user attribute can be determined by performing, by the determination unit 107, determination using a threshold. Therefore, using the determination result, an ad can be drawn, for example. In addition, in the case of calculating the prior probabilities or likelihoods as described above, the prior probabilities or likelihoods can be calculated by simply counting the number of user identifiers and events for obtaining a numerator and a denominator. Thus, it even becomes possible to use software incapable of handling loops.

In addition, although the case in which the calculation information storage unit 102 is included has been described in the embodiment, the posterior probability calculating apparatus 1 may not necessarily include the calculation information storage unit 102. In the case where the posterior probability calculating apparatus 1 does not include the calculation information storage unit 102, the prior probability calculating unit 103 and the likelihood calculating unit 104 may accumulate the calculated probabilities in an external storage unit, and the prior probability calculating unit 103 and the likelihood calculating unit 104 may perform calculations every time the accepting unit 105 accepts calculation target information.

In addition, although the case in which the determination unit 107 is included has been described in the embodiment, the posterior probability calculating apparatus 1 may not necessarily include the determination unit 107. In the case where the posterior probability calculating apparatus 1 does not include the determination unit 107, the output unit 108 may output the posterior probability calculated by the posterior probability calculating unit 106.

In addition, although the case in which the posterior probability calculating unit 106 calculates the posterior probability by normalizing the to-be-normalized posterior probability has been mainly described in the embodiment, the embodiment is not limited to this case. The posterior probability may be calculated by additionally calculating a denominator in the naive Bayes method and dividing the to-be-normalized posterior probability by the denominator.

In addition, software that realizes the posterior probability calculating apparatus 1 according to the embodiment is a program such as that follows. That is, the program is a program that causes a computer capable of accessing a user information storage unit that stores a plurality of items of user information, which is information that associates a user identifier for identifying a user, the user attribute of the user, and log information that is the log of an event(s) performed by the user regarding a web page, to function as the following: a prior probability calculating unit that calculates, for each user attribute, a prior probability that is a probability that a user has a certain user attribute, by using the plurality of items of user information; a likelihood calculating unit that calculates, for each combination of a user attribute and an event, a likelihood that is a probability that a user with a certain user attribute has performed a certain event, by using the plurality of items of user information; an accepting unit that accepts calculation target information including event log information and a user attribute; a posterior probability calculating unit that calculates, according to the naive Bayes method using the prior probabilities and the likelihoods, a posterior probability that is a probability that a user who has performed each event included in the log information included in the calculation target information accepted by the accepting unit has the user attribute included in the calculation target information; and an output unit that outputs information regarding the posterior probability calculated by the posterior probability calculating unit.

In the embodiment, processes (functions) may be realized through centralized processing performed by a single apparatus (system), or may be realized through distributed processing performed by a plurality of apparatuses. Also in the embodiment, needless to say, two or more communication units included in a single apparatus may be physically realized by a single unit.

Also in the embodiment, elements may be configured by dedicated hardware. Alternatively, elements that are realizable by software may be realized by execution of a program. For example, elements may be realized by reading and executing a software program recorded on a recording medium, such as a hard disk or a semiconductor memory, by a program execution unit such as a central processing unit (CPU).

Note that functions realized by the above-mentioned program do not include functions that are only realizable by hardware. For example, functions realized by the above-mentioned program do not include functions that are only realizable by hardware, such as a modem, an interface card, and the like in an obtaining unit that obtains information, an output unit that outputs information, and the like.

FIG. 6 is a schematic diagram illustrating an exemplary appearance of a computer that executes the above-described program and realizes the above-described embodiment. The above-described embodiment may be realized by computer hardware and a computer program executed on the computer hardware.

Referring to FIG. 6, a computer system 1100 includes a computer 1101 including a compact-disc read-only memory (CD-ROM) drive 1105 and a floppy disk (FD) drive 1106, a keyboard 1102, a mouse 1103, and a monitor 1104.

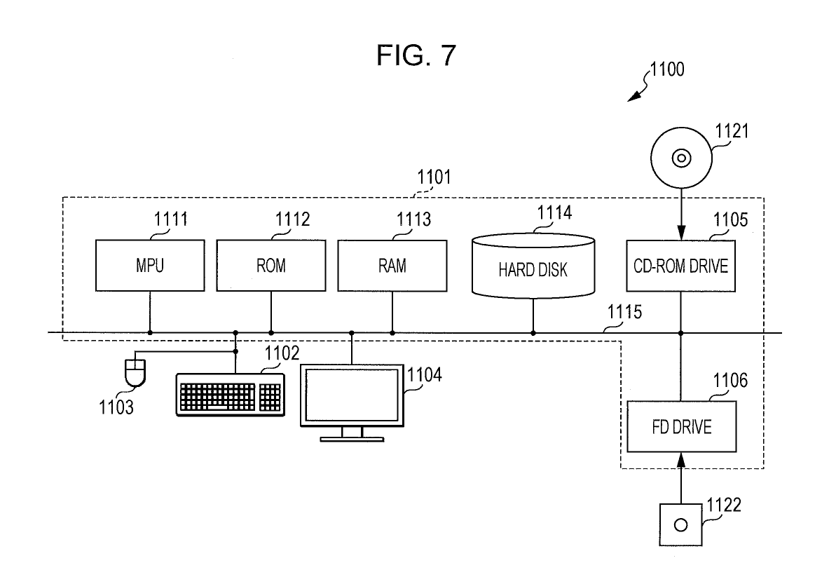

FIG. 7 is a diagram illustrating the internal configuration of the computer system 1100. Referring to FIG. 7, the computer 1101 includes, in addition to the CD-ROM drive 1105 and the FD drive 1106, an MPU 1111, a ROM 1112 for accumulating a program such as a boot-up program, a random-access memory (RAM) 1113 that is connected to the MPU 1111, temporarily accumulates a command of an application program, and provides a temporary storage space, a hard disk 1114 that accumulates an application program, a system program, and data, and a bus 1115 that connects the MPU 1111, the ROM 1112, and so forth to one another. The computer 1101 may include a network card that is not illustrated in the drawings and that provides a connection to a LAN.

A program that causes the computer system 1100 to execute the functions of the embodiment of the present invention may be accumulated in a CD-ROM 1121 or an FD 1122, which may be inserted into the CD-ROM drive 1105 or the FD drive 1106, and may be transferred to the hard disk 1114. Alternatively, the program may be transmitted to the computer 1101 via a network that is not illustrated in the drawings, and may be accumulated in the hard disk 1114. In execution of the program, the program is loaded to the RAM 1113. The program may be directly loaded from the CD-ROM 1121, the FD 1122, or a network.

It is not necessary for the program to include an operating system (OS) or a third party program or the like that causes the computer 1101 to execute the functions of the embodiment of the present invention. The program may include only a portion of a command that calls an appropriate function (module) in a controlled mode to obtain a desired result. How the computer system 1100 operates is the related art, and a detailed description thereof is omitted.

The present invention is not limited to the above-described embodiment. Various changes can be made, and, needless to say, these changes are included in the scope of the present invention. In addition, the term “unit” in each unit in the embodiment may be replaced with the term “portion” or the term “circuit”.

As described above, the posterior probability calculating apparatus and the like according to the embodiment of the present invention are advantageous in that the posterior probability can be obtained in a short period of time and are useful as a posterior probability calculating apparatus and the like which calculate the posterior probability that a user who has performed a certain event has a user attribute.

What is claimed is:

1. A posterior probability calculating apparatus comprising:
a user information storage unit that stores a plurality of items of user information, the user information being information that associates a user identifier for identifying a user, a user attribute of the user, and log information that is a log of an event performed by the user regarding a web page;
a prior probability calculating unit that calculates, for each user attribute, a prior probability that is a probability that a user has a certain user attribute, by using the plurality of items of user information;
a likelihood calculating unit that calculates, for each combination of a user attribute and an event, a likelihood that is a probability that a user with a certain user attribute has performed a certain event, by using the plurality of items of user information;
an accepting unit that accepts calculation target information including event log information and a user attribute;
a posterior probability calculating unit that calculates, according to the naive Bayes method using the prior probabilities and the likelihoods, a posterior probability that is a probability that a user who has performed each event included in the log information included in the calculation target information accepted by the accepting unit has the user attribute included in the calculation target information; and
an output unit that outputs information regarding the posterior probability calculated by the posterior probability calculating unit.

2. The posterior probability calculating apparatus according to claim 1,
wherein the posterior probability calculating unit calculates a to-be-normalized posterior probability that is a value in accordance with a posterior probability corresponding to the calculation target information, and
wherein the posterior probability calculating unit additionally calculates a to-be-normalized posterior probability for each user attribute included in a set obtained by excluding the user attribute included in the calculation target information accepted by the accepting unit from a set-of user attributes corresponding to all users, and calculates the posterior probability corresponding to the calculation target information by normalizing the to-be-normalized posterior probability corresponding to the calculation target information using the to-be-normalized posterior probability for each user attribute included in the obtained set.

3. The posterior probability calculating apparatus according to claim 1,
wherein the log of an event is the log of an event for each type of device with which the event has been performed,
wherein the prior probability calculating unit calculates a prior probability for each type of device,
wherein the likelihood calculating unit calculates a likelihood for each type of device,
wherein the accepting unit accepts calculation target information that additionally includes device type information indicating a type of device, and
wherein the posterior probability calculating unit calculates a posterior probability corresponding to the type of device indicated by the device type information included in the calculation target information accepted by the accepting unit by using a prior probability and a likelihood in accordance with the type of device.

4. The posterior probability calculating apparatus according to claim 1, wherein the event is at least one of browsing a web page and entering a search keyword.

5. The posterior probability calculating apparatus according to claim 1, further comprising:
a determination unit that determines whether a user who has performed each event in the log of an event included in the calculation target information accepted by the accepting unit has the user attribute included in the calculation target information by determining whether a posterior probability calculated in accordance with the calculation target information is greater than or equal to a predetermined threshold,
wherein the output unit outputs a determination result obtained by the determination unit.

6. A posterior probability calculating method processed using a user information storage unit that stores a plurality of items of user information, the user information being information that associates a user identifier for identifying a user, a user attribute of the user, and log information that is a log of an event performed by the user regarding a web page, a prior probability calculating unit, a likelihood calculating unit, an accepting unit, a posterior calculating unit, and an output unit, the method comprising:
a prior probability calculating step of calculating, with the prior probability calculating unit, for each user attribute, a prior probability that is a probability that a user has a certain user attribute, by using the plurality of items of user information;
a likelihood calculating step of calculating, with the likelihood calculating unit, for each combination of a user attribute and an event, a likelihood that is a probability that a user with a certain user attribute has performed a certain event, by using the plurality of items of user information;
an accepting step of accepting, with the accepting unit, calculation target information including event log information and a user attribute;
a posterior probability calculating step of calculating, with the posterior probability calculating unit, according to the naive Bayes method using the prior probabilities and the likelihoods, a posterior probability that is a probability that a user who has performed each event included in the log information included in the calculation target information accepted in the accepting step has the user attribute included in the calculation target information; and
an output step of performing, with the output unit, an output regarding the posterior probability calculated in the posterior probability calculating step.

7. A non-transitory computer-readable recording medium storing a program that causes a computer capable of accessing a user information storage unit that stores a plurality of items of user information, the user information being information that associates a user identifier for identifying a user, a user attribute of the user, and log information that is a log of an event performed by the user regarding a web page to function as:
a prior probability calculating unit that calculates, for each user attribute, a prior probability that is a probability that a user has a certain user attribute, by using the plurality of items of user information;
a likelihood calculating unit that calculates, for each combination of a user attribute and an event, a likelihood that is a probability that a user with a certain user attribute has performed a certain event, by using the plurality of items of user information;
an accepting unit that accepts calculation target information including event log information and a user attribute;
a posterior probability calculating unit that calculates, according to the naive Bayes method using the prior probabilities and the likelihoods, a posterior probability that is a probability that a user who has performed each event included in the log information included in the calculation target information accepted by the accepting unit has the user attribute included in the calculation target information; and
an output unit that outputs information regarding the posterior probability calculated by the posterior probability calculating unit.
